(19) United States
(12) Patent Application Publication
(10) Pub. No.: US 2023/0066266 A1
(43) Pub. Date: Mar. 2, 2023

(54) AQUEOUS GROW NUTRIENT CONTROL SYSTEM AND CALIBRATION

(71) Applicants: Geoffrey C. Landis, Commerce, CA (US); Matt Xu, Commerce, CA (US); Morris Gasmer, Commerce, CA (US)

(72) Inventors: Geoffrey C. Landis, Commerce, CA (US); Matt Xu, Commerce, CA (US); Morris Gasmer, Commerce, CA (US)

(21) Appl. No.: 17/459,510

(22) Filed: Aug. 27, 2021

(51) Int. Cl. A01G 31/02

(52) U.S. Cl. CPC A01G 31/02; A01G 2031/006

(57) ABSTRACT

An aquaponic grow system includes a plurality of sensors for sensing nutrient levels in liquid provided to a grow chamber, and to adjust nutrient levels based on the sensed levels. In some embodiments the system includes a plurality of sensors configured to sense nutrient levels in a common chamber, with the system configured to calibrate the sensors.

### BACKGROUND OF THE INVENTION

The present invention relates generally to fertilization and irrigation (“fertigation”) systems for crops, and more particularly to fertigation systems for closed-loop aqueous (hydroponic or aeroponic) grown crops and calibration of sensors used in such systems.

Aqueously grown crops generally maintain roots of the crops in an aqueous rich environment, with the roots either in a liquid solution or a mist environment. For example, hydroponically grown crops generally maintain roots of the crops in a liquid solution of water and nutrients. Also for example, aeroponically grown crops generally maintain roots of the crops in an aqueous mist environment, with the mist formed using a liquid solution, and the mist providing water and nutrients for plant growth.

Maintaining an appropriate level of nutrients in the liquid solution may be difficult particularly for a closed-loop system, in which liquid solution injected into a grow chamber is reused in a recirculating manner. For example, the crops may intake different amounts of nutrients from the solution, and this may change over time. Also for example, a large quantity of aqueous solution generally may be present about the crop roots, particularly for hydroponic systems, forming a relatively large reservoir of solution. Injecting nutrients into the solution may result in variations in concentration of the nutrients within the reservoir, and there may be significant delays or time lags between time of injection of the nutrients and dispersal of the nutrients within the reservoir. These delays or time lags may make sampling of the solution for nutrients prone to errors, and increase difficulties in accurate sampling of nutrient levels.

In addition, sensors used for the sampling of the solution may benefit from periodic recalibration. Recalibration of sensors, however, may be a relatively lengthy process, increasing costs and also possibly resulting in excessive time in which sampling is not performed.

### BRIEF SUMMARY OF THE INVENTION

Some aspects of the invention relate to nutrient injection in an aqueous fertigation system for growing plants. Some aspects of the invention relate to calibration of sensors for determining nutrient levels in an aqueous fertigation system for growing plants. Some aspects of the invention relate to solutions for injecting nutrients into liquid provided to growing plants.

In some aspects, solutions injected into liquid provided to growing plants include a target ion, concentration of which is to be increased in the liquid provided to growing plants, and a plurality of counter ions to the target ion. In some embodiments at least some of the target ions and different ones of the counter ions may together form ionic compounds. In some embodiments the solutions may additionally include pH adjusters, which may be an acid, a base, or a combination of acids and bases, to adjust the solutions to have a pH the same as a desired pH of the liquid provided to the growing plants.

In some aspects, sensors for the fertigation system are calibrated using solutions with concentrations of ions of interest proportionally the same or similar to those of desired concentrations of the ions of interest in liquid provided to the growing plants.

Some embodiments provide a nutrient control system for use with growing plants, comprising: a liquid solution line for providing liquid solution to the growing plants and for receiving liquid solution from the growing plants, so as to recirculate the liquid solution; a chamber selectively coupled to the liquid solution line and to the reference solution tanks; a plurality of sensors for sensing ion levels of ions in solution in the chamber; a plurality of nutrient tanks containing nutrients coupled to the liquid solution line; a plurality of reference solution tanks containing reference solutions, each of the plurality of reference solution tanks containing a concentration of the ions within 10 percent of a desired concentration of the ions to be delivered to the growing plants multiplied by a value, the value for each of the plurality of reference solution tanks being different; and a controller configured to control addition of the nutrients to the liquid solution based on sensed ion levels in solution in the chamber, configured to perform sensor calibration based on sensed ion levels in solution in the chamber, and to selectively couple the chamber to the liquid solution line or to the reference solution tanks.

In some embodiments the value for a first of the reference solution tanks is less than one and the value for a second of the reference solution tanks is greater than one. In some embodiments the plurality of reference solution tanks consist of two reference solution tanks. In some embodiments a number of the reference solution tanks is less than a number of the plurality of sensors. In some embodiments the controller is configured to couple the chamber to a first of the reference solution tanks and store sensed ion levels of a first plurality of the sensors with liquid from the first of the reference solution tanks in the chamber, and to couple the chamber to a second of the reference solution tanks and store sensed ion levels of the first plurality of the sensors, and to determine calibration curves for the first plurality of the sensors based on the stored sensed ion levels. In some embodiments the first plurality of the sensors comprise the plurality of sensors. In some embodiments at least 80 percent of the plurality of reference solution tanks contain a concentration of the ions within 5 percent of the desired concentration of the ions to be delivered to the growing plants multiplied by the value. In some embodiments at least 60 percent of the plurality of reference solution tanks contain a concentration of the ions within 2 percent of the desired concentration of the ions to be delivered to the growing plants multiplied by the value. In some embodiments at least some of the nutrient tanks have solutions for a different one of the ions, each of the nutrient tanks for the different one of the ions having a solution including a plurality of different ionic compounds that each include the different one of the ions.

Some embodiments provide a nutrient control system for use with growing plants, comprising: a liquid solution line for providing liquid solution to the growing plants and for receiving liquid solution from the growing plants, so as to recirculate the liquid solution; a chamber coupled to the liquid solution line; a plurality of sensors for sensing ion levels of ions in solution in the chamber; a plurality of nutrient tanks containing nutrients coupled to the liquid solution line, at least some of the nutrient tanks having solutions for a different one of the ions, each of the nutrient tanks for the different one of the ions having a solution including a plurality of different ionic compounds that each include the different one of the ions; and a controller configured to control addition of the nutrients to the liquid solution based on sensed ion levels in solution in the chamber.

In some embodiments the ions include nitrate ions, and calcium ions or potassium ions. In some embodiments a first of the nutrient tanks has a solution for calcium ions, the solution formed using at least three of a calcium sulfate, a calcium nitrate, a calcium acetate, and a calcium phosphate, and a second of the nutrient tanks has a solution for nitrate ions, the solution formed using at least three of an ammonium nitrate, a calcium nitrate, a magnesium nitrate, and a potassium nitrate. In some embodiments a third of the nutrient tanks has a solution for potassium ions, the solution formed using at least three of a potassium sulfate, a potassium nitrate, a potassium bicarbonate, and a potassium phosphate. In some embodiments at least some of the solutions of first, second, and third nutrient tanks further include pH adjustors such that the pH of the solution in the nutrient tank is the same as a desired pH of liquid provided to the growing plants. In some embodiments the ions include nitrate ions, calcium ions, and potassium ions. In some embodiments a first of the nutrient tanks has a solution for nitrate ions, the solution formed using at least an ammonium nitrate, a calcium nitrate, a magnesium nitrate, and a potassium nitrate. In some embodiments a second of the nutrient tanks has a solution for calcium ions, the solution formed using at least a calcium sulfate, a calcium nitrate, a calcium acetate, and a calcium phosphate. In some embodiments a third of the nutrient tanks has a solution for potassium ions, the solution formed using at least a potassium sulfate, a potassium nitrate, a potassium bicarbonate, and a potassium phosphate. In some embodiments a first of the nutrient tanks has a solution for nitrate ions, the solution formed using at least an ammonium nitrate, a calcium nitrate, a magnesium nitrate, and a potassium nitrate, wherein a second of the nutrient tanks has a solution for calcium ions, the solution formed using at least a calcium sulfate, a calcium nitrate, a calcium acetate, and a calcium phosphate, and wherein a third of the nutrient tanks has a solution for potassium ions, the solution formed using at least a potassium sulfate, a potassium nitrate, a potassium bicarbonate, and a potassium phosphate. In some embodiments each of the solutions additionally has pH adjustors such that the pH of the solution in the nutrient tank is the same as a desired pH of liquid provided to the growing plants. Some embodiments further comprise a plurality of reference solution tanks containing reference solutions, at least some of the plurality of reference solution tanks containing a concentration of ions of a desired concentration of the ions to be delivered to the growing plants multiplied by a value, the value for each of the plurality of reference solution tanks being different; and wherein the chamber is selectively coupled to the liquid solution line and to the reference solution tanks; and wherein the controller is further configured to perform sensor calibration based on sensed ion levels in solution in the chamber, and to selectively couple the chamber to the liquid solution line or to the reference solution tanks.

Some embodiments provide solutions for a plant growing system, in which sensors sense target ion concentrations in liquid to be provided to growing plants and a controller commands injections of the solutions into the liquid in order to more closely achieve desired target ion concentrations in the liquid, the solutions each comprising: a target ion of interest in a predetermined concentration and a plurality of counter ions.

In some embodiments at least some of the target ions of interest and the plurality of counter ions for the at least some of the target ions of interest are provided by salts of the target ions of interest. In some embodiments at least one of the target ions of interest is a calcium ion, and the calcium ion and the counter ions for the calcium ion are provided by at least some of calcium sulfate, calcium nitrate, calcium acetate, and calcium phosphate. In some embodiments at least one of the target ions of interest is a potassium ion, and the potassium ion and the counter ions for the potassium ion are provided by at least some of potassium sulfate, potassium nitrate, potassium bicarbonate, and potassium phosphate. In some embodiments at least one of the target ions of interest is a nitrate ion, and the nitrate ion and the counter ions for the nitrate ion are provided by at least some of ammonium nitrate, calcium nitrate, magnesium nitrate, and potassium nitrate. In some embodiments at least some of the solutions include pH adjustors such that pH of the at least some of the solutions is the same as a desired pH of the liquid.

Some embodiments provide a nutrient control and calibration system for use with growing plants, comprising: a housing; a chamber, the chamber within the housing, the chamber selectively coupled to a liquid solution line, for provision of liquid nutrient solution to growing plants, and to a plurality of reference solution tanks; a plurality of sensors for sensing ion levels of ions in solution in the chamber; the plurality of reference solution tanks in the housing, the plurality of reference solution tanks containing reference solutions; at least one heater for heating the sensors and the plurality of reference solution tanks; and a controller configured to perform sensor calibration based on sensed ion levels in solution in the chamber, and to selectively couple the chamber to the liquid solution line or to the reference solution tanks.

These and other aspects of the invention are more fully comprehended upon review of this disclosure.

### BRIEF DESCRIPTION OF THE FIGURES

FIG. 1 is a block diagram of an agricultural system in accordance with aspects of the invention.

FIG. 2 is a flow diagram of a process for controlling nutrient levels in liquid provided to a grow chamber.

FIG. 3A is a block diagram of components associated with sensing of nutrients in liquid solution provided to a grow chamber in accordance with some embodiments.

FIG. 3B is a front view of a cart holding components associated with sensing of nutrients in liquid solution provided to a grow chamber in accordance with some embodiments.

FIG. 4 is a flow diagram of a process for performing sensor calibration in accordance with aspects of the invention.

FIG. 5 is a top view of a representation of an embodiment of a flow chamber in accordance with aspects of the invention.

FIG. 6 is a cross-sectional view of a representation of an embodiment of a flow chamber.

FIG. 7 is a block diagram illustrating portions of an example embodiment of circuitry utilized in measurement of ions or cations, reflecting nutrient levels in the liquid solution.

### DETAILED DESCRIPTION

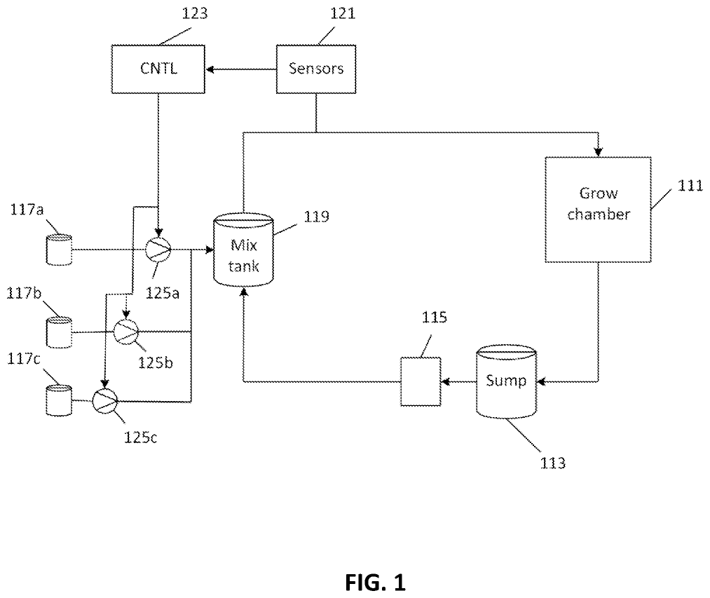

FIG. 1 is a block diagram of an agricultural system in accordance with aspects of the invention. In some embodiments the agricultural system is an aeroponics system.

The system includes a grow chamber 111. Crops are grown in the grow chamber. In some embodiments individual plants are sprouted outside of the grow chamber, and then grown from sprouts to maturity in the grow chamber. In some embodiments the grow chamber provides for aquaponic growth of the crops. In some embodiments the grow chamber provides for hydroponic growth of plants. In some embodiments the chamber provides for aeroponic growth of plants. In some embodiments the grow chamber includes one or more vertical walls for mounting of plants for aeroponic growth, with an aqueous mist provided within the grow chamber, for example by way of misting nozzles. In some embodiments grow chamber is as discussed in U.S. patent application Ser. No. 15/360,876, entitled PLANT GROWING SYSTEMS AND METHODS and filed with the United States Patent and Trademark Office on Nov. 23, 2016, the disclosure of which is incorporated by reference for all purposes. With regard to some aspects, discussion herein may be in terms of a grow chamber for convenience, although some aspects may not require a chamber per se.

The grow chamber receives a liquid solution. In some embodiments roots of the crops are immersed in the liquid solution. In some embodiments the liquid solution is used to generate a mist, with the mist generally enveloping roots of the plants. The liquid solution generally includes water and plant nutrients. Liquid from the grow chamber, which if a mist precipitates, liquid collects in a sump 113. The sump may be at or towards a bottom of the grow chamber, although the sump may be outside of the grow chamber, and may be a separate tank, as illustrated in FIG. 1 for clarity. Liquid from the sump is passed to a cleaning or sanitization unit 115. In some embodiments the sanitization unit cleans or sterilizes the liquid using one or more of a method using one or more chemicals, for example chlorine, a method using ultraviolet light, a method using filters, and/or a method using ozone.

The cleaned or sanitized liquid is combined with nutrients in a mix tank 119. The mix tank allows for mixing of the liquid and the nutrients. In some embodiments preferably the mix tank holds less than 50 gallons of liquid. In some embodiments preferably the mix tank holds less than 40 gallons of liquid. In some embodiments preferably the mix tank holds approximately 4 gallons of liquid. In some embodiments a mixer is used in place of the mix tank, and in some embodiments the mixer is a confluence of two pipes, and in some embodiments the mixer is a mixing valve.

The nutrients, which may also be in aqueous form, are provided by pumps 125a-c. Each of the pumps 125a-c receives nutrients from a separate corresponding nutrient tank 117a-c, respectively, with each of the nutrient tanks generally containing different nutrients, or mixtures of nutrients. The liquid with added nutrients is provided to the grow chamber.

In some embodiments each nutrient tank holds a solution targeted to a specific ion. In some embodiments each solution targeted to a specific ion is provided the solution from what may be considered a plurality of different ionic compounds, each including the specific ion. For example, a first nutrient tank may hold a solution targeted to a calcium ion, and the calcium ion may be provided in the solution by some or all of calcium sulfate, calcium nitrate, calcium acetate, and calcium phosphate. Similarly, a second nutrient tank may hold a solution targeted to a potassium ion, and the potassium ion may be provided in the solution by some or all of potassium sulfate, potassium nitrate, potassium bicarbonate, and potassium phosphate. Also similarly, a third nutrient tank may hold a solution targeted to a nitrate ion, and the nitrate ion may be provided in the solution by some or all of ammonium nitrate, calcium nitrate, magnesium nitrate, and potassium nitrate. In some embodiments the ionic compounds may be viewed as including a target ion and a corresponding counter ion, and each nutrient tank may hold in solution a target ion and a plurality of corresponding counter ions, with concentration of the target ion much higher than concentration of any of the counter ions. Such a situation may be beneficial, for example, to avoid unduly imbalancing concentration of any of the counter ions in the liquid provided to the growing plants when adjusting concentration of the target ion in that liquid. In some embodiments different ones of the ionic compounds may be selected, for example based on a desired constituents and concentrations in liquid provided to particular growing plants. In some embodiments concentration of target ions in the nutrient solutions are two to seven times greater than a concentration of target ions desired to be provided to the growing plants. In addition, in various embodiments pH adjusters may also be in the solution of the nutrient tanks. The pH adjusters may be used to obtain a pH for liquid in the nutrient tanks that is the same as or similar to that of a desired pH for liquid provided to the growing plants. In some embodiments the pH adjusters may be an acid, a base, a combination of an acid and a base, or a combination of acids and bases.

Sensors 121 sense one or more aspects of the liquid provided to the grow chamber. In some embodiments the sensors sense the liquid after the addition of the added nutrients, but before the liquid is provided to the grow chamber. In some embodiments the sensors sense the liquid before the addition of the added nutrients, for example liquid that has been returned from the grow chamber. In some embodiments the sensor may sense, for example, one or more of the pH of the liquid, potassium content of the liquid, magnesium content of the liquid, or other constituents of the liquid.

Levels of nutrients in the liquid provided to the grow chamber are related to the amount of nutrients provided by the pumps. The pumps, and therefore the amount of added nutrients, are controlled by a controller 123. The controller controls the pumps, at least in part, based on information from the sensors 121. In some embodiments the controller comprises at least one processor, which may operate in accordance with program instructions. In some embodiments the controller comprises a personal computer. In some embodiments the controller comprises circuitry including a digital signal processor.

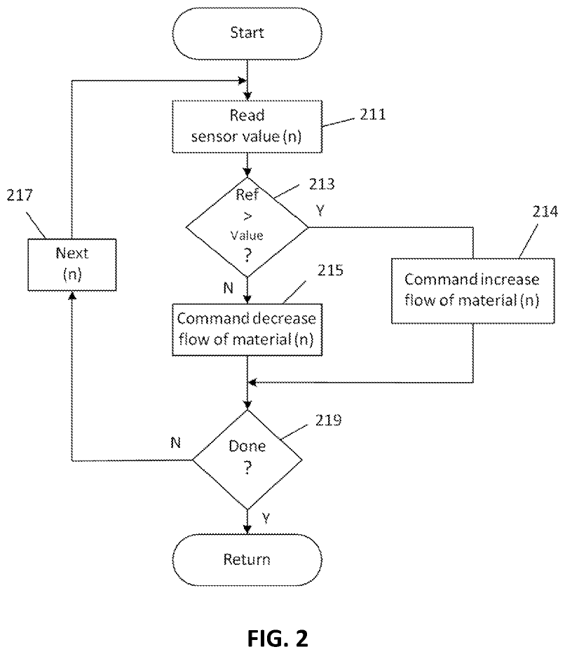

FIG. 2 is a flow diagram of a process for controlling nutrient levels in liquid provided to a grow chamber. In some embodiments the grow chamber is a chamber for aeroponically growing plants, for example crops. In some embodiments the nutrients include some or all of potassium, calcium, sodium, chlorine and/or other elements, which may be in ionic form or in combination with various elements. In some embodiments the process is performed by the system of FIG. 1, or parts of the system of FIG. 1. In some embodiments the process is performed by at least one processor. In some embodiments the processor is coupled, for example by electrical and/or electronic circuitry, to pumps and/or chemical and/or electrochemical sensors.

In block 211 the process reads a value from a sensor. The sensor may be, for example, a sensor as in the system of FIG. 1, with the sensor sensing an aspect of liquid provided to a grow chamber. In various embodiments the sensor is one of a plurality of sensors. For example, in some embodiments the sensor may be one of four sensors, in some embodiments the sensor may be one of eight sensors, or, more generally, the sensor may be one of n sensors, n being an integer greater than one. In some embodiments the sensor is an ion channel sensor. In some embodiments the sensor is an ion selective electrode sensor. In various embodiments at least some of the plurality of sensors are ion selective electrode sensors. In some embodiments all of the plurality of sensors are ion selective electrode sensors.

In block 213 the process determines if the value read from the sensor is less than a reference value. In some embodiments the reference value is indicative of a desired concentration of an ion in the liquid provided to the grow chamber. In some embodiments the reference value is a programmable value, and may be changed from time to time. In some embodiments the process determines if the value read from the reference value is greater than the reference plus a tolerance range, or if the value read from the sensor is less than the reference value minus a tolerance range. In other words, in some embodiments, and in some cases most embodiments, the process determines if the value read from the sensor indicates whether the ion concentration in the liquid is above or below an acceptable ion concentration range.

If the reference value is greater than the value read from the sensor, or in some embodiments if the value read from the sensor indicates a concentration below the acceptable ion concentration range, the process proceeds to block 214. If the reference value is less than the value read from the sensor, or in some embodiments if the value read from the sensor indicates a concentration above the acceptable ion concentration range, the process proceeds to block 215.

If the process proceeds to block 214, in block 214 the process commands an increase in flow of a nutrient n, n being a nutrient corresponding to the ion concentration measured by the sensor n. In some embodiments the process commands a pump to increase pumping of the nutrient. In some embodiments the process commands the pump to pump nutrient at an increased flow rate. In some embodiments the process commands a pump to pump nutrient for a specified period of time, and in some embodiments at a specified flow rate.

If the process proceeds to block 215, in block 215 the process commands a decrease in flow of a nutrient n, n being a nutrient corresponding to the ion concentration measured by the sensor n. In some embodiments the process commands a pump to decrease pumping of the nutrient. In some embodiments the process commands the pump to pump nutrient at a decreased flow rate. In some embodiments the process commands a pump to pump nutrient for a specified period of time, and in some embodiments at a specified flow rate.

In block 219 the process determines if there are more sensors to process. If so, the process proceeds to block 217 and increments n, with the process thereafter beginning processing of the next sensor with operations of block 211 and so on. Otherwise the process returns.

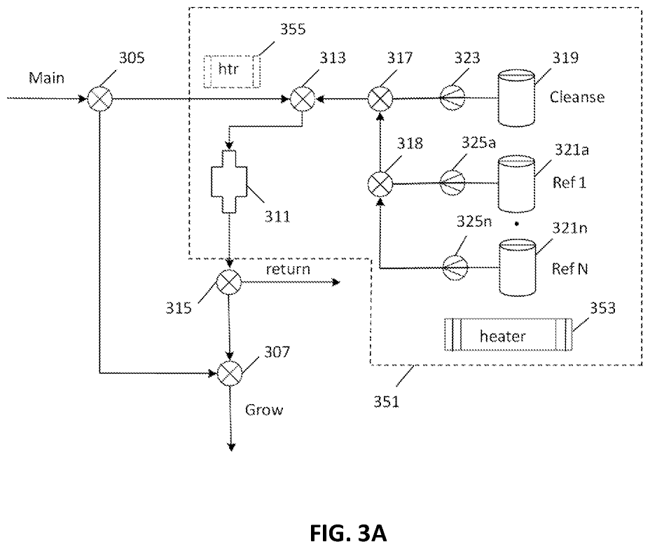

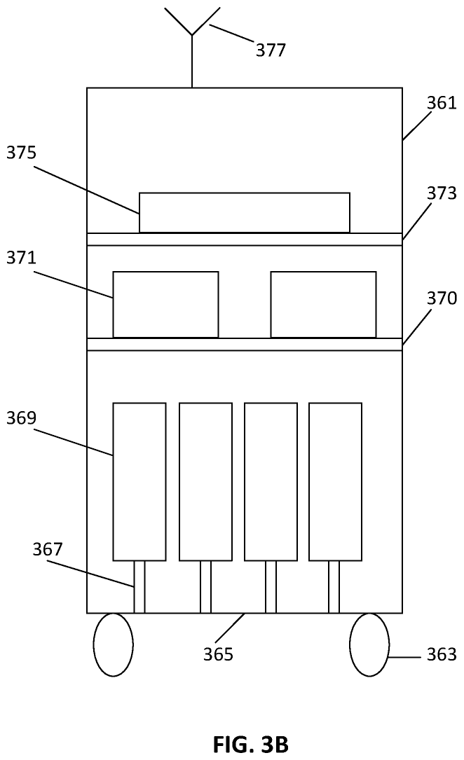

FIG. 3 is a block diagram of components associated with sensing of nutrients in liquid solution provided to a grow chamber in accordance with some embodiments. In some embodiments the components are associated with the sensors of the system of FIG. 1.

A flow chamber 311 includes a plurality of sensors for sensing nutrients in the liquid solution. In normal operation liquid solution is provided to the grow chamber and nutrients in the liquid solution are sensed. Accordingly, considering the components of FIG. 3, a main line provides liquid solution for provision to the grow chamber. During normal operation, the liquid solution passes through a first valve 305 and a second valve 313 to the flow chamber, in which levels of the nutrients are sensed by the sensors. Exiting the sensors, again during normal operation, the liquid solution passes through valves 315 and 307 and proceeds to the grow chamber. The configuration for the valves 305, 307, 313, and 315, and the other valves of the embodiment of FIG. 3 are exemplary only. In various embodiments different configurations of valves, in layout, type, and/or number, may be used.

At times, however, calibration of the sensors may be desired. During calibration operations, in accordance with aspects of the invention, valves 305 and 307 are operated, with these and other valves controlled for example by the controller of FIG. 1, such that the liquid solution bypasses the flow chamber. With the liquid solution bypassing the flow chamber, the liquid solution instead flows from the main line into a bypass line connecting valves 305 and 307. In some embodiments, however, a bypass line may not be used, with the flow chamber instead receiving a portion of the flow selectively provided to the flow chamber, and in other embodiments flow of liquid to the grow chamber may be interrupted during calibration.

The flow chamber therefore does not receive liquid solution from the main line during sensor calibration. Instead, during calibration operations, valve 313 is operated such that the flow chamber receives cleansing solution or reference solutions from cleansing solution tank 319 or reference solution tanks 321a-n, respectively. In the embodiment of FIG. 3, the solution, after passage through the flow chamber, is directed to a return line by valve 315. The return line returns the solution to the tanks from which it came, in some embodiments, or to a waste container, in other embodiments, or a combination of the two, for example on a tank-by-tank basis.

Each of the reference solution tanks 321a-n holds a different reference solution. In some embodiments each reference solution tank holds a reference solution with a different single nutrient of interest. In some embodiments the reference solution tanks may be grouped into subsets, with each subset having a different single nutrient of interest, but with each tank in a subset having a different level of that nutrient. In some embodiments each reference solution tank may hold a solution with a plurality of nutrients of interest, with nutrient levels varying across reference tanks. In some embodiments each reference solution tank holds a reference solution with a plurality of nutrients of interest, with each nutrient having a concentration within predetermined range of being proportional to desired concentrations of those nutrients in liquid provided to growing plants. In some embodiments the predetermined range is 10%. In some embodiments the predetermined range is 5 percent for at least 80% of those nutrients. In some embodiments the predetermined range is 2% for at least 60% of those nutrients. In some embodiments the predetermined range is greater for nutrients with ions that interfere less with measurements made for other ions of interest with ion selective electrodes, and in some embodiments the predetermined range is smaller for nutrients with ions that interfere more with measurements made for other ions of interest with ion selective electrodes. In some embodiments the proportional concentrations of nutrients in one tank is less than desired concentrations of those nutrients in liquid provided to growing plants in a first tank, and greater in a second tank. In some embodiments use of only such a first tank and such a second tank is sufficient, for purposes of performing actual measurements, to calibrate sensors for those nutrients. In some embodiments only such a first tank, such a second tank, and such a third tank are used, for purposes of performing actual measurements, to calibrate sensor for those nutrients, with the use of three such tanks allowing for a calibration curve generated using three points, instead of two. In addition, in various embodiments pH adjusters may also be in the solution of the reference tanks. The pH adjusters may be used to obtain a pH for liquid in the reference tanks that is the same as or similar to that of a desired pH for liquid provided to the growing plants. In some embodiments the pH adjusters may be an acid, a base, a combination of an acid and a base, or a combination of acids and bases.

In some embodiments the reference solution tanks and the flow chamber including the plurality of sensors are within a housing 351. The housing includes a heater 353. The heater allows for heating of the reference solution tanks and the flow chamber, for example to a predetermined temperature. In some embodiments, however, the heater itself may be external to the housing, with a conduit or other mechanism for passing heat into the housing. In some embodiments the heater may primarily heat only a portion of the housing, for example solution in the reference solution tanks and/or the flow chamber. In some embodiments the heater is configured to maintain the temperature in the housing, or one or more predetermined locations in the housing, at a predetermined temperature. In some embodiments the predetermined temperature is 80 degrees Fahrenheit. In some embodiments the predetermined temperature is a temperature above an expected ambient temperature of the housing, without heating. In some embodiments the heater is configured to maintain a temperature of sensor membranes and solution in contact with the sensor membranes at a constant temperature. In some embodiments the heater is configured to reduce variations in temperature of the sensor membranes. In this regard, in some embodiments the housing includes an additional heater 355 for heating liquid nutrient solution to be provided to the growing plants, prior to the liquid nutrient solution reaching the flow chamber.

A pump is associated with each of the tanks, with a cleansing solution pump 323 providing cleansing solution from the cleansing solution tank and reference solution pumps 325a-n providing reference solution from reference solution tanks 321a-n. The pumps, like the valves, may be controlled by a controller, for example the controller of the system of FIG. 1. Solution from the tanks selectively, on a tank by tank basis, flows through valves, for example valves 317, 318 connecting lines from the pumps to the valve 313, which is coupled to an inlet of the flow chamber 311. In addition, in some embodiments a compressed air tank or compressed air line may be selectively coupled to the flow chamber, for example to assist in expelling fluid from the flow chamber, and particularly from sensors of the flow chamber, during cleansing operations.

FIG. 3B is a front view of an embodiment of a cart holding components associated with sensing of nutrients in liquid solution provided to a grow chamber in accordance with some embodiments. In some embodiments the cart provides the housing of FIG. 3A. The cart includes a top surface and a bottom surface connected by a back wall, two sidewalls, and a bottom. A front wall is formed by a door, which may be hinged on one side. In FIG. 3B the door is removed, for purposes of providing increased visibility of contents within the cart. The embodiment of FIG. 3A includes wheels 363 coupled to the bottom of the cart, for example to provide for increased ease of mobility of the cart.

The bottom of the cart forms a base 365 for placement of items in the cart. A plurality of stands are on the base, for example stand 367. In the embodiment of FIG. 3A, four stands are provided. A solution tank is on each of the stands. In some embodiments some of the solution tanks may hold reference solutions, and one or some of the solution tanks may hold cleaning and/or washing solutions, which may include enzyme solutions. The reference solutions may be or include the reference solutions discussed with respect to FIG. 3A. In some embodiments the stands may include extendable slides, for example to allow for increased ease of placement of the solution tanks within the cart.

The cart includes a first shelf 370 above the solution tanks. Flow chambers are positioned on the first shelf, for example flow chamber 371. In some embodiments the first shelf may have apertures, through which portions of the flow chambers may extend. The flow chambers have sensors within the flow chambers that may be exposed to solution, for example as variously discussed herein. Solution may be selectively provided to the flow chamber by way of conduits and valves (not shown in FIG. 3B) coupling the solution tanks to the flow chambers and coupling a liquid nutrient solution line to the flow chambers.

In some embodiments one or more heaters (not shown in FIG. 3B) within the cart, for example mounted to a wall of the cart. The heaters may be used, for example, as discussed with respect to FIG. 3A. In some embodiments the side walls and/or back wall include vents for allowing for ventilation of the interior of the cart.

The cart also includes a second shelf 373, above the flow chambers. An electronic equipment box 375 is shown on the second shelf. The electronic equipment box may include one or more controllers, for example including processors, for performing sensor calibration processing and calculations, commanding valve operations, and/or functions commonly performed by computer or industrial control equipment. The electronic equipment box is also coupled to an antenna 377, shown as on top of the cart, for wirelessly communicating with a network.

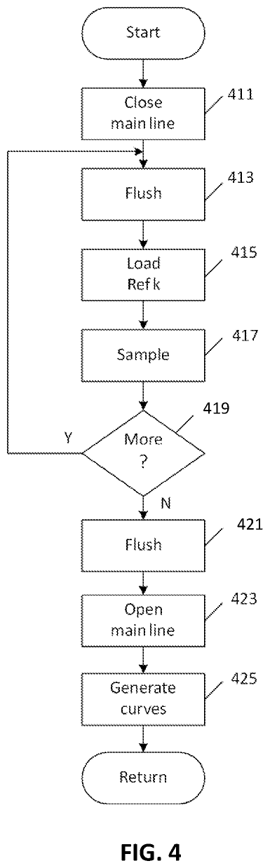

FIG. 4 is a flow diagram of a process for performing sensor calibration in accordance with aspects of the invention. In some embodiments the process is performed using the components of FIG. 3. In some embodiments the process is performed by the system of FIG. 1, for example using the components of FIG. 3. In some embodiments the controller of FIG. 1 generates commands to perform the operations of the process of FIG. 4.

In block 411 the process closes a connection from a main line to the sensors. The main line, for example, may carry a liquid solution intended to be provided to a grow chamber. In some embodiments the connection from the main line is closed by way of operating a valve.

In block 413 the process flushes a flow chamber used for the sensors. In some embodiments the process flushes the flow chamber by opening valves allowing fluid present in the flow chamber to exit the flow chamber. In some embodiments the process may force compressed air, for example air under greater than atmospheric pressure, into the flow chamber to assist in expelling fluid present in the flow chamber to exit the flow chamber. In some embodiments the process flushes the flow chamber by passing a cleansing solution through the flow chamber. In some embodiments the cleansing solution is water. In some embodiments the cleansing solution is an aqueous solution containing one or more of a detergent, chlorine, or some other cleansing solution. In some embodiments the cleansing solution is a reference solution, for example having a known level or levels of particular nutrients. The reference solution, for example, may be a reference solution known to be a next reference solution for use during the calibration process. In some embodiments the process may also force compressed air into the flow chamber to expel, or assist in expelling, cleansing solution from the flow chamber.

In block 415 the process loads the flow chamber with a reference solution. In various embodiments the reference solution is one of a plurality of reference solutions. For example, there may be n reference solutions, n an integer greater than 1, and the loaded reference solution may be considered a reference solution k, k being an integer between 1 and n, inclusive. In some embodiments the reference solution is an aqueous solution with a predetermined level of a nutrient. In some embodiments a plurality of the reference solutions each include a different predetermined level of the nutrient. In some embodiments a plurality of the reference solutions each include different predetermined levels of a plurality of nutrients. In some embodiments each of a plurality of reference solutions includes a plurality of nutrients of interest, with concentrations of those nutrients of interest being proportional to desired concentrations of those nutrients in liquid provided to growing plants.

In block 417 the process samples the reference solution in the flow chamber. In some embodiments the sampling is performed using one or more ion selective electrodes. In some embodiments the process samples the reference solution using an ion selective electrode for a particular ion. In some embodiments the process samples the reference solution using the ion selective electrode for the particular ion for a plurality of reference solutions, with in some embodiments ion selective electrodes for different particular ions used for different subsets of reference solutions. In some embodiments a plurality of ion selective electrodes, each for different particular ions, are used for some or all of the reference solutions.

In block 419 the process determines if there are more reference solutions to be used. In some embodiments only two reference solutions are used, with for example each reference solution including concentrations of nutrients that are proportional to desired concentrations of nutrients to be provided to growing plants. Otherwise the process continues to block 421 and flushes the flow chamber. The process thereafter opens the connection to the main line in block 423, allowing for liquid solution intended for the grow chamber to enter the flow chamber and be sensed for nutrient levels by the sensors.

In block 425 the process generates curves relating sensor output to nutrient levels for each of the sensors. In some embodiments the process uses two sensor readings for different ion levels, and generates a line or curve of ion concentration vs. sensor readings for each ion sensed by a sensor. In some embodiments the process uses at least three sensor readings for different ion levels, and generates a curve of ion concentration vs. sensor readings for each ion sensed by a sensor. In some embodiments the curve has a constant slope, in some embodiments the curve has a second order slope, and in some embodiments the curve has piecewise linear slopes.

The process thereafter returns.

In various embodiments the sensors are ion selective electrodes (ISEs). In general, for an ISE, an ion selective membrane allows for passage of, or prevents passage of, particular ions. At equilibrium, there will be a potential difference (membrane potential) between the two sides of the membrane. This membrane potential may be considered to be governed by the Nernst equation:

$$E = {E}^{0} - ( 2.303 \frac{R T}{n F} ) log a \qquad ( 1 )$$

where E is the measured potential, E⁰ is a constant characteristic of a particular ISE, R is the gas constant (8.314 J·mol⁻¹ K⁻¹), T is the temperature (in K), n is the valence charge of the target ion, F is the Faraday constant (96,485 C·mol⁻¹) and a is the activity of the target ion. Based on Equation 1, the measured potential difference is proportional to the logarithm of the target ion activity. Thus, the relationship between potential difference and ion activity can be determined by measuring the potential of two solutions of already-known ion activities (calibrants) and a plot based on the measured potential and logarithm of the ion activity.

Unfortunately, most ISEs have a membrane that is sensitive to a multiple ions which are similar in ion radius charge and mobility, which may complicate usage of the ISEs. For example, an ISE for sodium may be selective for Na+, but also responds to potassium K+ and lithium Li+. The selectivity constant for K+ may be 0.001 and for Li+ may be 0.01, which means that the K+ ion is contributing 0.001 of its concentration toward the potential of the electrode. In most agricultural fertigation solutions, the K+ concentration may be hundreds of times higher than that of Na+, and the interference may be significant and lead to undesired operations.

In order to calculate the influence of interfering ions regarding the final potential E, an extended Nernst equation, the Nikolsky-Eisenman equation, may be considered:

$$E = {E}^{0} - ( 2.303 \frac{R T}{n F} ) log ( {a}_{i} + \sum {K}_{i j} {a}_{j}^{\frac{{n}_{i}}{{n}_{j}}} ) \qquad ( 2 )$$

with

nᵢ=Valence charge of the primary ion I;
nⱼ=Valence charge of the interfering ion j;
aᵢ=Activity of the primary ion;
aⱼ=Activity of interfering ion; and
Kᵢⱼ=Selectivity constant (primary ion/interfering ion).

Some embodiments, make use of a concentration analysis of chemical composition in a desired fertigation solution. The desired fertigation solution concentrations may vary depending on various factors, for example the particular plants being grown, the stage of growth of the plants, and other factors. Nevertheless, the desired fertigation solution concentrations may be predetermined. With the desired fertigation solution concentrations predetermined, the relative ratios of ions in the desired fertigation solution concentrations are known. In such a case, with the relative activity ratio of interfering ion j, ion k and so on being Cᵢⱼ, Cᵢₖ, etc., and assuming that most interfering ions have the same valence charge, so nᵢ/nⱼ=1, equation 2 can be rewritten as:

$$E = {E}^{0} - ( 2.303 \frac{R T}{n F} ) log ( 1 + \sum {K}_{i j} {C}_{i j} ) - ( 2.303 \frac{R T}{n F} ) log ( {a}_{i} ) \qquad ( 3 )$$

Since Kᵢⱼ, Cᵢⱼ are constants, the measured potential difference is again proportional to the logarithm of the target ion activity, at least for concentrations approximate the desired fertigation solution concentrations.

As an example, desired fertigation solution (Nutrient Solution (N.S.)) concentrations may be as follows:

| | | Conc. in N.S. | Molarity in N.S. |
|---|---|---|---|
| | M.W. | (ppm) | (mmol) |
| SO₄²⁻ | 96 | 57 | 0.6 |
| P | 31 | 52 | 1.68 |
| Na⁺ | 23 | 13 | 0.57 |
| NO₃⁻ | 62 | 892.8 | 14.39 |
| Mg²⁺ | 24.3 | 30 | 1.23 |
| K⁺ | 39 | 320 | 8.21 |
| Cl⁻ | 35.5 | 18 | 0.51 |
| Ca²⁺ | 40 | 154 | 3.85 |

A 1× calibrant system may include:

| Chemical | Molarity (mmol) |
|---|---|
| MgSO₄ | 1.00 |
| Ca(NO₃)₂ | 3.85 |
| Mg(NO₃)₂ | 0.23 |
| KNO₃ | 6.53 |
| KH₂PO₄ | 1.68 |
| NaCl | 0.57 |

The calibration system concentration profile may be as follows:

| | Conc. in N.S. | Molarity in | Molarity in cal. |
|---|---|---|---|
| | (ppm) | N.S. (mmol) | system (mmol) |
| NO3 | 892.8 | 14.39 | 14.69 |
| K | 320 | 8.21 | 8.21 |
| Ca | 154 | 3.85 | 3.85 |
| Mg | 30 | 1.23 | 1.23 |
| Cl | 18 | 0.51 | 0.57 |
| Na | 13 | 0.57 | 0.57 |
| HCO3 | 73 | 1.2 | 0 |
| SO4 | 57 | 0.6 | 1.0 |
| P | 52 | 1.68 | 1.68 |

The above is a 1× calibrant for this specific fertigation system. In some embodiments, instead of or in addition to a 1× calibrant, a 0.5× calibrant and a 2× calibrant may be used. Readings from each of the sensors using the 0.5× calibrant and the 2× calibrant may be taken, to provide a two-point calibration. As indicated above, in some embodiments a resulting calibration curve may be considered linear, with the slope is only related to the primary ion measured by each ISE.

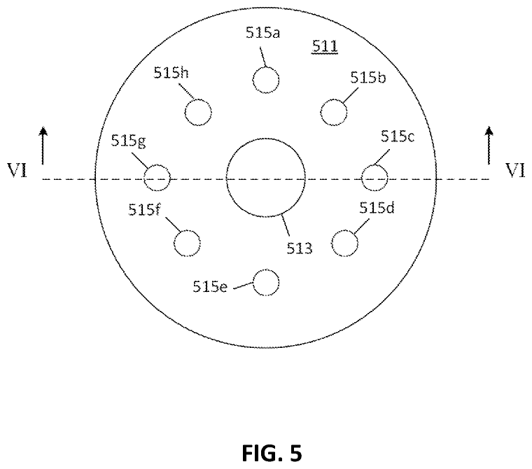

FIG. 5 is a top view of a representation of an embodiment of a flow chamber in accordance with aspects of the invention. In some embodiments the flow chamber of FIG. 5 may be used as the flow chamber of FIG. 3.

The flow chamber includes a generally circular upper surface 511. An inlet port 513 is present on the upper surface, approximately at a center of the upper surface in the embodiment of FIG. 5. A plurality of ion selective electrodes 515a-h extend through the upper surface and into the flow chamber. The embodiments of FIG. 5 includes 8 ion selective electrodes, the number of ion selective electrodes may differ in different embodiments. In many embodiments, each of the ion selective electrodes are for sensing levels of different ions in a solution. In some embodiments there may be redundancy for some or all of the ions, and some of the ion selective electrodes may be for the same ion.

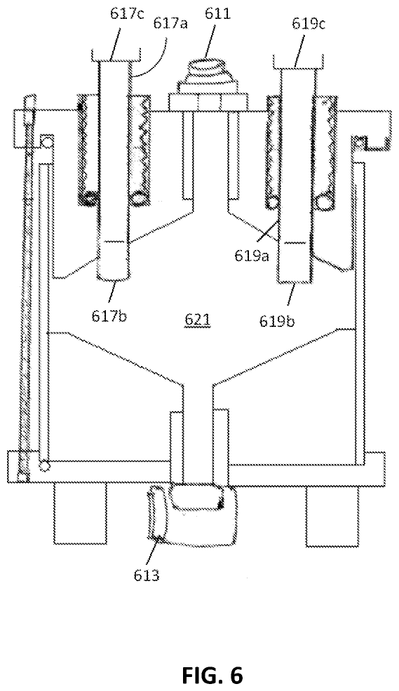

FIG. 6 is a cross-sectional view of a representation of an embodiment of a flow chamber, for example along the section VI-VI of the embodiment of FIG. 5. An inlet port 611 on a top of the flow chamber provides for passage of fluid into the flow chamber. A corresponding outlet port 613 is on a bottom of the flow chamber. In some embodiments the inlet port and the outlet port may be switched in relative position. In some embodiments the inlet port and the outlet port may be switched during operation, for example with the inlet port used at some times as the outlet port and the outlet port used at those times as the inlet port. In some embodiments the port on the bottom of the chamber is used for provision of liquid solution, with the liquid solution exiting the port on the top of the chamber, while the port on the top of the chamber is used for provision of compressed air to the chamber, with the compressed air exiting the port on the bottom of the chamber. Interior to the flow chamber, a chamber 621 allows for pooling of the fluid within the flow chamber. In some embodiments pooling of the fluid is encouraged by having a passage to the outlet port of slightly reduced diameter, as compared to a passage from the inlet port.

A plurality of ion selective electrode devices are inserted through a top of the flow chamber, with ends protruding into the chamber 621. Visible in FIG. 6 are two such devices. A first device includes a cylinder 617a having a first ion selective electrode accessible to the fluid by way of a first membrane 617b, with electrical connections available at a top 617c of the cylinder 617a. Similarly, a second device includes a cylinder 619a having a second ion selective electrode accessible to the fluid by way of a second membrane 619b, with electrical connections available at a top 619c of the cylinder 619a. In various embodiments the first membrane and the second membrane are permeable by different ions or cations, such that the first ion selective electrode effectively measures a different ion or cation than the second ion selective electrode.

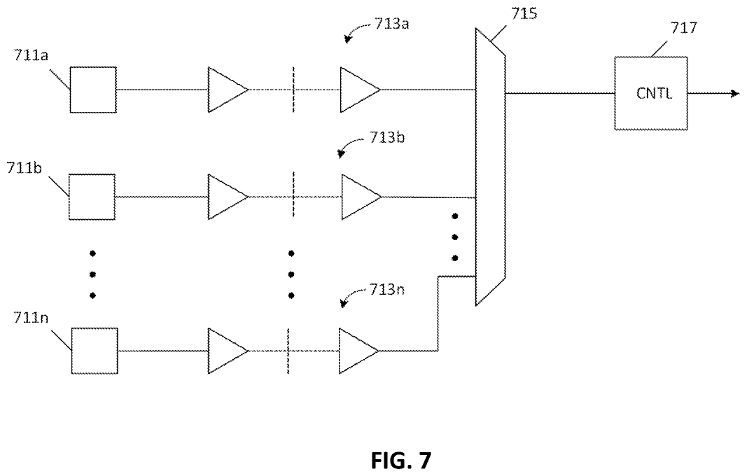

The ion selective electrodes are electrically coupled to circuitry allowing for measurement of the ions or cations. FIG. 7 is a block diagram illustrating portions of an example embodiment of circuitry utilized in measurement of ions or cations, reflecting nutrient levels in the liquid solution. In some embodiments the circuitry of FIG. 7 may be present, for example, in the system of FIG. 1, or a system similar to the system of FIG. 1. In FIG. 7, a plurality of ion selective electrodes 711a-n are each coupled to corresponding isolation amplifiers 713a-n. In some embodiments the isolation amplifiers are transformer-isolated isolated amplifiers. Outputs of the isolation amplifiers are provided to a multiplexer, which selectively selects one of its inputs and provides that input to the multiplexer output. In some embodiments the multiplexer is operated in a time-based round robin manner, with successive inputs successively provided to the output. The output is provided to control circuitry. In various embodiments the control circuitry may include an analog-to-digital controller (ADC), for example as may be available in a digital signal processor (DSP), in other embodiments the ADC may be separately provided.

Although the invention has been discussed with respect to various embodiments, it should be recognized that the invention comprises the novel and non-obvious claims supported by this disclosure.

What is claimed is:

1. A nutrient control system for use with growing plants, comprising:
a liquid solution line for providing liquid solution to the growing plants and for receiving liquid solution from the growing plants, so as to recirculate the liquid solution;
a chamber selectively coupled to the liquid solution line and to a plurality of reference solution tanks;
a plurality of sensors for sensing ion levels of ions in solution in the chamber;
a plurality of nutrient tanks containing nutrients coupled to the liquid solution line;
the plurality of reference solution tanks containing reference solutions, each of the plurality of reference solution tanks containing a concentration of the ions within 10 percent of a desired concentration of the ions to be delivered to the growing plants multiplied by a value, the value for each of the plurality of reference solution tanks being different; and
a controller configured to control addition of the nutrients to the liquid solution based on sensed ion levels in solution in the chamber, configured to perform sensor calibration based on sensed ion levels in solution in the chamber, and to selectively couple the chamber to the liquid solution line or to the reference solution tanks.

2. The nutrient control system of claim 1, wherein the value for a first of the reference solution tanks is less than one and the value for a second of the reference solution tanks is greater than one.

3. The nutrient control system of claim 2, wherein the plurality of reference solution tanks consist of two reference solution tanks.

4. The nutrient control system of claim 1, wherein a number of the reference solution tanks is less than a number of the plurality of sensors.

5. The nutrient control system of claim 1, wherein the controller is configured to couple the chamber to a first of the reference solution tanks and store sensed ion levels of a first plurality of the sensors with liquid from the first of the reference solution tanks in the chamber, and to couple the chamber to a second of the reference solution tanks and store sensed ion levels of the first plurality of the sensors, and to determine calibration curves for the first plurality of the sensors based on the stored sensed ion levels.

6. The nutrient control system of claim 5, wherein the first plurality of the sensors comprise the plurality of sensors.

7. The nutrient control system of claim 1, wherein at least 80 percent of the plurality of reference solution tanks contain a concentration of the ions within 5 percent of the desired concentration of the ions to be delivered to the growing plants multiplied by the value.

8. The nutrient control system of claim 1, wherein at least 60 percent of the plurality of reference solution tanks contain a concentration of the ions within 2 percent of the desired concentration of the ions to be delivered to the growing plants multiplied by the value.

9. The nutrient control system of claim 1, wherein at least some of the nutrient tanks have solutions for a different one of the ions, each of the nutrient tanks for the different one of the ions having a solution including a plurality of different ionic compounds that each include the different one of the ions.

10. A nutrient control system for use with growing plants, comprising:
a liquid solution line for providing liquid solution to the growing plants and for receiving liquid solution from the growing plants, so as to recirculate the liquid solution;
a chamber coupled to the liquid solution line;
a plurality of sensors for sensing ion levels of ions in solution in the chamber;
a plurality of nutrient tanks containing nutrients coupled to the liquid solution line, at least some of the nutrient tanks having solutions for a different one of the ions, each of the nutrient tanks for the different one of the ions having a solution including a plurality of different ionic compounds that each include the different one of the ions; and
a controller configured to control addition of the nutrients to the liquid solution based on sensed ion levels in solution in the chamber.

11. The nutrient control system of claim 10, wherein the ions include nitrate ions, and calcium ions or potassium ions.

12. The nutrient control system of claim 11, wherein a first of the nutrient tanks has a solution for calcium ions, the solution formed using at least three of a calcium sulfate, a calcium nitrate, a calcium acetate, and a calcium phosphate, and a second of the nutrient tanks has a solution for nitrate ions, the solution formed using at least three of an ammonium nitrate, a calcium nitrate, a magnesium nitrate, and a potassium nitrate.

13. The nutrient control system of claim 12, wherein a third of the nutrient tanks has a solution for potassium ions, the solution formed using at least three of a potassium sulfate, a potassium nitrate, a potassium bicarbonate, and a potassium phosphate.

14. The nutrient control system of claim 13, wherein at least some of the solutions of first, second, and third nutrient tanks further include pH adjustors such that the pH of the solution in the nutrient tank is the same as a desired pH of liquid provided to the growing plants.

15. The nutrient control system of claim 10, wherein the ions include nitrate ions, calcium ions, and potassium ions.

16. The nutrient control system of claim 15, wherein a first of the nutrient tanks has a solution for nitrate ions, the solution formed using at least an ammonium nitrate, a calcium nitrate, a magnesium nitrate, and a potassium nitrate.

17. The nutrient control system of claim 15, wherein a second of the nutrient tanks has a solution for calcium ions, the solution formed using at least a calcium sulfate, a calcium nitrate, a calcium acetate, and a calcium phosphate.

18. The nutrient control system of claim 15, wherein a third of the nutrient tanks has a solution for potassium ions, the solution formed using at least a potassium sulfate, a potassium nitrate, a potassium bicarbonate, and a potassium phosphate.

19. The nutrient control system of claim 12, wherein a first of the nutrient tanks has a solution for nitrate ions, the solution formed using at least an ammonium nitrate, a calcium nitrate, a magnesium nitrate, and a potassium nitrate, wherein a second of the nutrient tanks has a solution for calcium ions, the solution formed using at least a calcium sulfate, a calcium nitrate, a calcium acetate, and a calcium phosphate, and wherein a third of the nutrient tanks has a solution for potassium ions, the solution formed using at least a potassium sulfate, a potassium nitrate, a potassium bicarbonate, and a potassium phosphate.

20. The nutrient control system of claim 19, wherein each of the solutions additionally has pH adjustors such that the pH of the solution in the nutrient tank is the same as a desired pH of liquid provided to the growing plants.

21. The nutrient control system of claim 10, further comprising a plurality of reference solution tanks containing reference solutions, at least some of the plurality of reference solution tanks containing a concentration of the ions of a desired concentration of ions to be delivered to the growing plants multiplied by a value, the value for each of the plurality of reference solution tanks being different; and
wherein the chamber is selectively coupled to the liquid solution line and to the reference solution tanks; and
wherein the controller is further configured to perform sensor calibration based on sensed ion levels in solution in the chamber, and to selectively couple the chamber to the liquid solution line or to the reference solution tanks.

22. Solutions for a plant growing system, in which sensors sense target ion concentrations in liquid to be provided to growing plants and a controller commands injections of the solutions into the liquid in order to more closely achieve desired target ion concentrations in the liquid, the solutions each comprising:
a target ion of interest in a predetermined concentration and a plurality of counter ions.

23. The solutions of claim 22, wherein at least some of the target ions of interest and the plurality of counter ions for the at least some of the target ions of interest are provided by salts of the target ions of interest.

24. The solutions of claim 22, wherein at least one of the target ions of interest is a calcium ion, and the calcium ion and the counter ions for the calcium ion are provided by at least some of calcium sulfate, calcium nitrate, calcium acetate, and calcium phosphate.

25. The solutions of claim 22, wherein at least one of the target ions of interest is a potassium ion, and the potassium ion and the counter ions for the potassium ion are provided by at least some of potassium sulfate, potassium nitrate, potassium bicarbonate, and potassium phosphate.

26. The solutions of claim 22, wherein at least one of the target ions of interest is a nitrate ion, and the nitrate ion and the counter ions for the nitrate ion are provided by at least some of ammonium nitrate, calcium nitrate, magnesium nitrate, and potassium nitrate.

27. The solutions of claim 22, wherein at least some of the solutions include pH adjustors such that pH of the at least some of the solutions is the same as a desired pH of the liquid.

28. A nutrient control and calibration system for use with growing plants, comprising:
a housing;
a chamber, the chamber within the housing, the chamber selectively coupled to a liquid solution line, for provision of liquid nutrient solution to growing plants, and to a plurality of reference solution tanks;
a plurality of sensors for sensing ion levels of ions in solution in the chamber;
the plurality of reference solution tanks in the housing, the plurality of reference solution tanks containing reference solutions;
at least one heater for heating the sensors and the plurality of reference solution tanks; and
a controller configured to perform sensor calibration based on sensed ion levels in solution in the chamber, and to selectively couple the chamber to the liquid solution line or to the reference solution tanks.
